(19) United States
(12) Patent Application Publication
(10) Pub. No.: US 2017/0083312 A1
(43) Pub. Date: Mar. 23, 2017

(54) METHOD AND SYSTEM FOR CROWD-SOURCED ALGORITHM DEVELOPMENT

(71) Applicant: MC10, INC., LEXINGTON, MA (US)

(72) Inventors: Jesus Pindado, Lexington, MA (US); Melissa Ceruolo, Middleton, MA (US); Shyamal Patel, Somerville, MA (US); Ryan McGinnis, Winooski, VT (US); Paolo DePetrillo, Somerville, MA (US)

(73) Assignee: MC10, INC., LEXINGTON, MA (US)

(21) Appl. No.: 15/272,816

(22) Filed: Sep. 22, 2016

Related U.S. Application Data
(60) Provisional application No. 62/221,664, filed on Sep. 22, 2015.

(51) Int. Cl. G06F 9/44; H04W 4/00; H04L 29/08

(52) U.S. Cl. CPC G06F 8/77; H04L 67/1097; H04L 67/34; H04W 4/005

(57) ABSTRACT

A system for development of an algorithm for analysis of sensor data includes one or more wearable sensor devices, a smart device, and a cloud computing platform. The sensors in the wearable sensor device produce sensor data (e.g., physiological data) from a user that can be processed by a software algorithm in the wearable sensor device or by a connected smart device (e.g., a smartphone) via cloud computing, producing an algorithm output. The raw sensor data along with other information, such as the algorithm output and sensor data features can be sent to the cloud computing platform for storage and to enable developers to access the data in order to modify the software algorithms. The wearable sensor device can be configured to send more or less data to the cloud computing platform according to the performance of the software algorithm.

### CROSS-REFERENCE TO RELATED APPLICATIONS

This application claims any and all benefits as provided by law including benefit under 35 U.S.C. §119(e) of the U.S. Provisional Application No. 62/221,664, filed Sep. 22, 2015, the contents of which are incorporated herein by reference in its entirety

### STATEMENT REGARDING FEDERALLY SPONSORED RESEARCH

Not Applicable

### REFERENCE TO MICROFICHE APPENDIX

Not Applicable

### BACKGROUND

Technical Field of the Invention

The present invention is directed to crowd-sourced algorithm and application development, and more particularly, to methods and systems for enabling multiple development teams to participate and compete in the development of algorithms and software applications. Further, the present invention can include a device that supports development by providing firmware mode switching to facilitate algorithm evaluation.

Description of the Prior Art

Software development can be a complex task requiring the cooperation of numerous individuals to develop computer based algorithms and software. Sometimes, the software development is outsourced to external groups of software developers. In addition, Crowd-sourced software development is an emerging approach. Under this approach, the software development services can be provided by a large unaffiliated group of people, such as an online community, rather than by employees and contractors. In addition, much of the development can be managed using the shared distributed resources, such as cloud computing. See, for example, Wei-Tek Tsai, Wenjun Wu, Michael N. Huhns, “Cloud-Based Software Crowdsourcing”, IEEE Internet Computing, vol.18, no. 3, pp. 78-83, May-June 2014, doi:10.1109/MIC.2014.46, which is hereby incorporated by reference.

### SUMMARY

Algorithm development for wearable sensor based software applications involves the analysis of a significant amount of data generated by a large number of users. Data collection can be performed in a supervised setting under controlled conditions with a well-defined testing protocol to generate a labeled dataset. Once the data has been collected, algorithm developers can develop algorithms (and software applications) that analyze the data to extract features that are relevant to the problem being solved and produce the right outputs of interest from the input data. The data collection and the data analysis approach can happen in a clear, planned sequence. This traditional approach requires significant time and resources for (a) data collection and (b) algorithm development and validation, which can limit the amount of data that can be generated from each subject as well as the number of subjects. As a result, algorithms developed on a small sample size often do not perform as well when applied to large population and improving them can take a long time and require significant resources.

The present invention is directed to a novel wearable computing architecture that enables the generation of labeled datasets from a large number of users in an unsupervised setting and enables an algorithm development process, whereby the data collection and algorithm development and improvement can occur simultaneously and in an ongoing basis.

In accordance with some embodiments, the system can include three basic components, 1) one or more wearable sensors and/or devices, 2) one or more smart devices (e.g., smartphones or other Bluetooth enabled devices or hubs or gateways), and 3) a cloud computing platform.

In accordance with some embodiments, at least one of the wearable sensors and/or devices can generate a data stream (e.g., data and other information from sensors). The data stream can include one or more of the following types of data from a range of different sensors (e.g., accelerometers, gyroscopes, ECG, EMG, GSR etc.), including 1) Raw sensor data, 2) parameters used by an algorithm as inputs, and 3) algorithm output (e.g. activity data, processed sensor data, features, tokens or activity attributes). The wearable sensor devices can also communicate with other wearable sensor devices, wearable stimulation devices and hub devices (e.g., smartphones, hubs and/or gateway devices) to send and receive data between the devices. In accordance with some embodiments, the wearable sensor device can be flexible, stretchable and/or conformal and adapted to be adhered to the body using an adhesive material. In accordance with some embodiments, the wearable sensor device can be included in a body worn device, such as a brace, a bracelet or anklet or an article of clothing.

The smartphone or hub or gateway, can include any device that can communicate with the wearable sensor device and the cloud computing platform. The hub or gateway can be a personal computer (PC) or other programmable device (e.g., smartphone, dedicated hub or gateway) that can be configured to communicate with the wearable sensor and the cloud computing platform. In accordance with some embodiments, the smartphone or hub can be configured to receive input from the user and sensors in the smartphone can be configured to collect additional data or metadata relating to the data and/or other information received from the wearable sensing device. In accordance with some embodiments, the smartphone or hub can use information input by the user to generate ground truth labels that can be used to characterize the activity of the user or data received from the wearable sensor device worn by the user. In accordance with some embodiments, the smartphone or hub can include components and sensors (e.g., clocks and calendars, GPS sensors, temperature sensors, accelerometer sensors, gyros, cameras, and light sensors) and can use those components and sensors to collect contextual data and information associated with the activity or the user at the time the sensor data is produced or received. The smartphone or hub can also be configured to act as the controller for the wearable sensor device. The smartphone or hub can also be configured to send commands (e.g., wirelessly via a wireless communication facility such as Bluetooth, Near Field Communication (NFC), Radio Frequency Identification (RFID), WiFi, or Zigbee) to control the operation of the wearable sensing device as well as upload software and firmware updates. The smartphone or hub can also be configured as a gateway to send data (e.g., user data and information received from the wearable sensor device) to and receive data from (e.g., commands and firmware updates for the wearable sensor device) the cloud computing platform/infrastructure.

The cloud computing platform and infrastructure can function as a data aggregation and data distribution system, a data storage system as well as a computing platform for data analytics and algorithm development (training/validation/deployment).

In accordance with some embodiments, users can be prompted by the smartphone or hub to provide information used to generate ground truth labels, as they go about doing daily activities. The prompts can be as simple as asking the user to tag or label their current activity, offer positive/negative confirmation about an automatically detected activity, or perform a specific activity for a fixed duration. Other means to capture ground truth include using data from the smartphone (i.e. from embedded sensors, GPS), environmental and social data, and data from other apps and devices. The labeled user data will then be pushed to the cloud for aggregation and storage, where one or more learning algorithms can use the new data to update its internal state and/or models or parameters to improve its accuracy for all users, a group of users or an individual user. The updated algorithm can then be pushed to the wearable device via a firmware or app update. This process can continue until a desired level of accuracy is achieved.

In accordance with some embodiments of the invention, the cloud platform can be primarily used to capture, store, and expose or distribute the raw data, labels, and performance targets to algorithm developers (e.g., internal or external) that can collaborate and/or compete (e.g., for points, money, or reputation) to develop and contribute new and improved algorithms that meet or exceed performance goals. The platform can also receive new algorithms and automatically test, evaluate, and rank them with fresh, more diverse and/or out of sample data. In accordance with some embodiments, if the performance of the new algorithms exceeds that of the old algorithms, or if a new algorithm is developed to measure or track a new activity, the platform can be used to push (e.g., manually or automatically) the new algorithms into the wearable sensor devices through the smartphone or hub device, such as in the form of a firmware or software update.

In accordance with some embodiments of the invention, the wearable sensor device can be configured to support a closed-loop algorithm development process. The wearable sensor device can be configured to facilitate a development process that utilizes data from a large number of users by utilizing a firmware design that can be configured to accommodate more than one use mode. In accordance with some embodiments of the invention, the wearable sensor device firmware can be configured using different memory management implementations, which can be include partitioning the memory (e.g. flash memory) to collect and store data using both a circular buffer and file system scheme.

In accordance with some embodiments, a circular buffer data storage configuration can be used for continuous data synchronization of algorithm outputs to the cloud platform. This mode optimizes the speed at which processed data is streamed from the device to the cloud, for immediate aggregation and visualizations by end users. In this mode, the user can set or confirm a label or marker to indicate a specific event or activity through the companion mobile application software interface. If the maturity or confidence level of the algorithm is not over a certain threshold, then the lower-level data set that is used by the algorithm in the wearable sensor device can optionally be included with the output that is sent to the cloud. For instance, if one or more of the ground truth labels from the user (or confidence levels from other sources) indicate a class match probability of less than 80%, the server or another element in the system could trigger a flag such that upon the next Bluetooth transmission or connection, the smartphone can send a command to the wearable sensor device which causes a change in the mode of operation of the wearable sensor device. For example, the wearable device can change from a mode wherein the only algorithm generated output is transmitted to the smartphone or hub to a mode wherein, in addition to algorithm generated output, additional data, metadata and/or signal features are transmitted to the smartphone or hub. The data, metadata and/or signal features, can include raw sensor data, information such as parameters used by the algorithm in processing the raw sensor data and information characterizing the raw data or attributes of the raw data. This information can be used to train the algorithm and to improve its confidence level.

In accordance with some embodiments, a file system data storage configuration can be used for to store separate recorded sessions (e.g., of raw sensor data or processed sensor data and metadata and parameters) corresponding to activity monitored over a period of time. In this embodiment, start and end commands can be used to define unique recording sessions. The user can query the wearable sensor device through the smartphone or hub to tag or label one or more of the sessions with information, such as for example, personal information, the type of activity, and the on-body location of the wearable sensor device which can be sent to the smartphone or hub and the cloud. This enables the cloud to store a database of user labeled activities that can be used for algorithm development.

In accordance with some embodiments, the user or a service provider can manually set the wearable sensor device modes. In accordance with some embodiments, the wearable sensor device can be configured to automatically change operating modes as a function of algorithm output, confidence levels (e.g., a low confidence intervals or unknown output causes the device to switch into a higher fidelity monitoring mode) and/or a comparison of detected activity and user reported ground truth.

In accordance with some embodiments of the invention, the algorithm output data along with any other data, metadata and/or signal features produced by each algorithm can be stored in the cloud computing platform and for later review and analysis. The development team can use this data to tune and/or modify their algorithms to its performance.

In accordance with some embodiments, after the development team improves the algorithm, the firmware update containing the improved algorithm or additions to an existing algorithm can be uploaded through the smartphone or hub to the wearable sensor device.

These and other capabilities of the invention, along with the invention itself, will be more fully understood after a review of the following figures, detailed description, and claims.

### BRIEF DESCRIPTION OF THE FIGURES

The accompanying drawings, which are incorporated into this specification, illustrate one or more exemplary embodiments of the inventions and, together with the detailed description, serve to explain the principles and applications of these inventions. The drawings and detailed description are illustrative, and are intended to facilitate an understanding of the inventions and their application without limiting the scope of the invention. The illustrative embodiments can be modified and adapted without departing from the spirit and scope of the inventions.

FIG. 1A is a block diagram of a system according to some embodiments of the invention.

FIG. 1B is a diagram of a wearable sensing device according to some embodiments of the invention;

FIG. 1C is a diagram of a wearable sensing device according to some embodiments of the invention;

FIG. 2 is a block diagram of a system according to some embodiments of the invention.

FIG. 3 is a schematic representation of data flow in a system according to some embodiments of the invention.

FIG. 4 is a block diagram of a crowd-sourced development system according to some embodiments of the invention.

FIG. 5 is a block diagram of firmware operating modes in a system according to some embodiments of the invention.

FIGS. 6A, 6B, and 6C show process flow diagrams of a crowd-sourced development system according to some embodiments of the invention.

### DETAILED DESCRIPTION OF PREFERRED EMBODIMENTS

The present invention is directed to a novel wearable computing architecture and an algorithm development platform. The wearable computing architecture enables the generation of labeled datasets from a large number of users in an unsupervised setting. The algorithm development platform enables a wide range of algorithm development processes, whereby the data collection and algorithm development and improvement can occur simultaneously and in an ongoing basis.

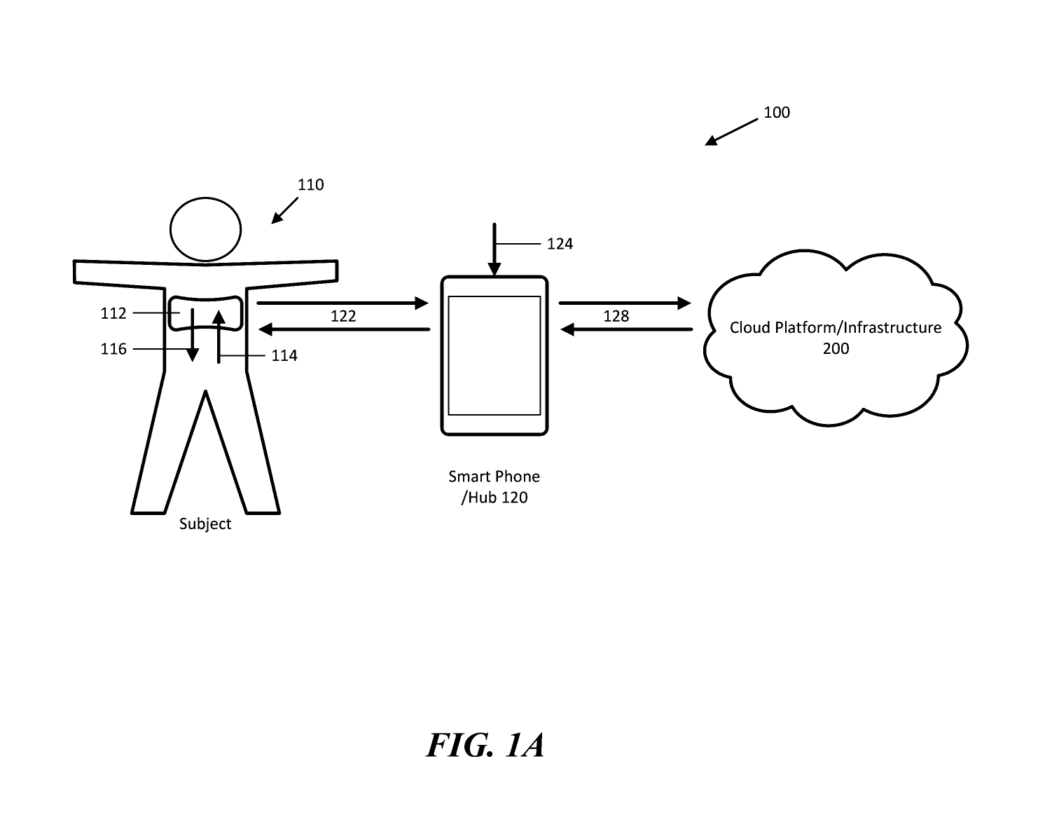

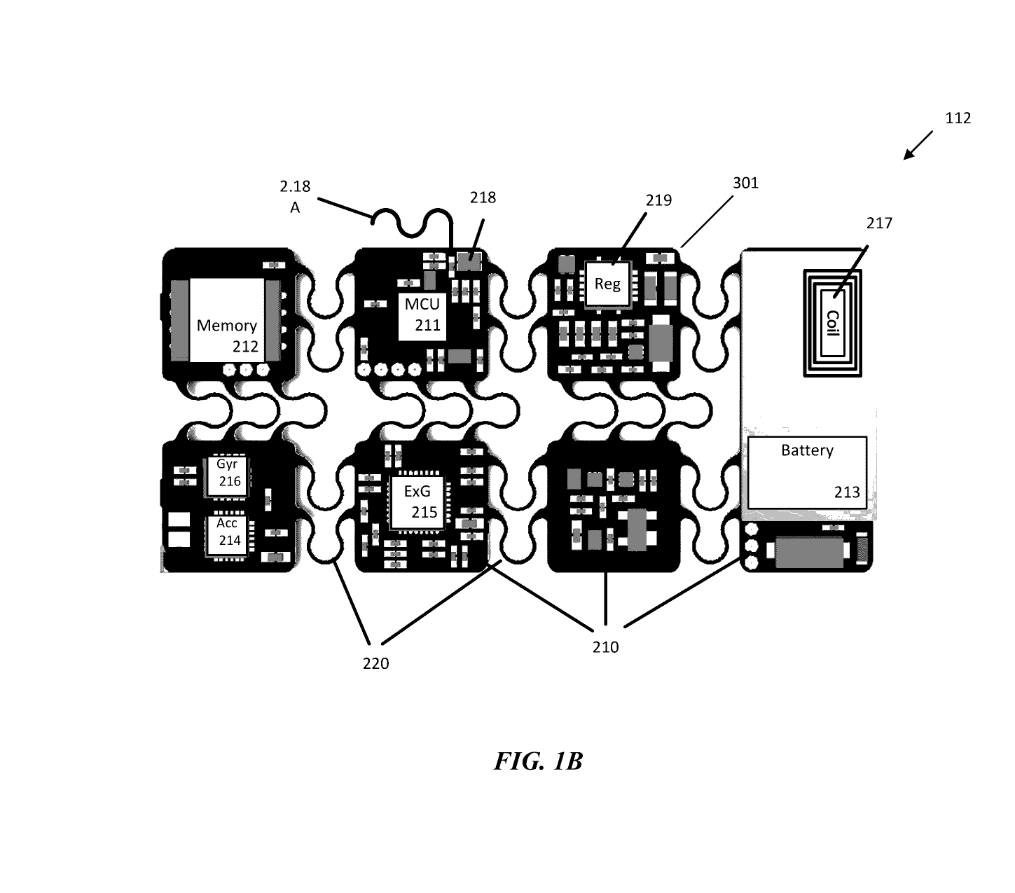

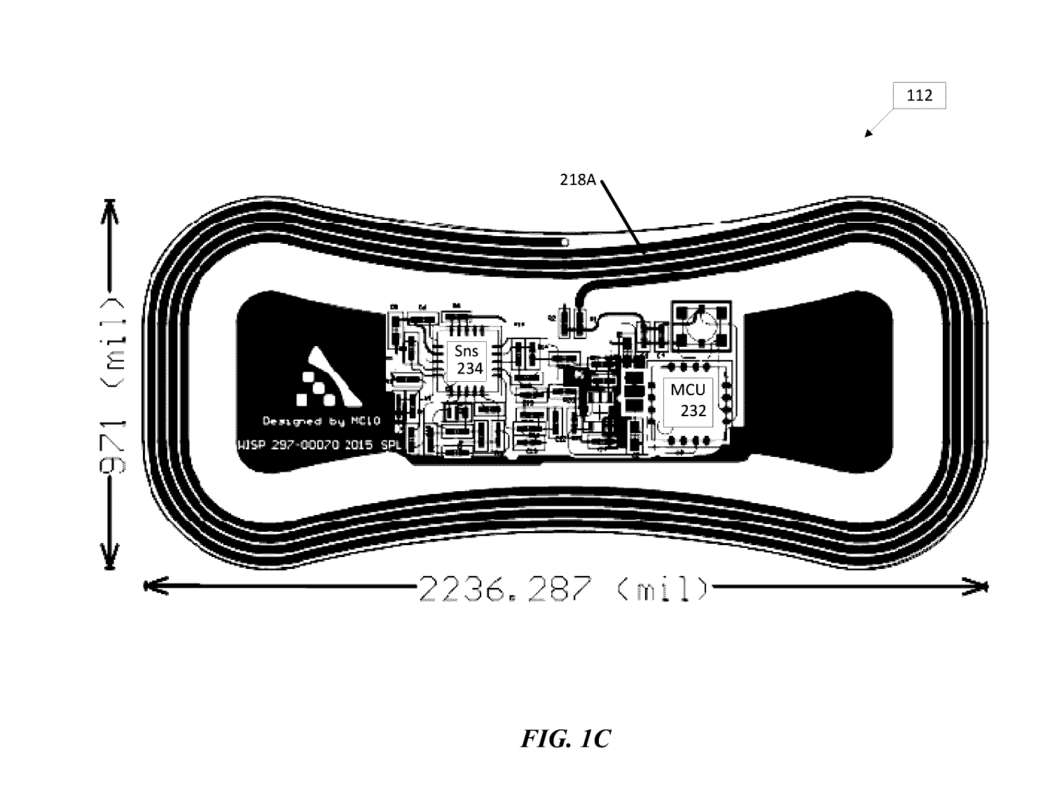

FIG. 1 shows a system 100 in accordance with some embodiments of the invention. The system 100 can include one or more wearable sensors and/or devices 112, one or more smartphones 120 (or other Bluetooth enabled devices or hubs or gateways), and a cloud computing platform 200. The wearable sensor device 112 can be worn on various locations on the body of a subject 110. The wearable sensor device 112 can include one or more sensors 114 including, for example, accelerometers, gyros, electrodes (e.g. ECG, EMG, EEG, GSR) and temperature sensors, for sensing conditions of the subject. The wearable sensor device 112 can also include transducers 116 for stimulating organs (e.g., nerves and/or muscles) at various locations on the body with electrical stimulation, ultrasonic stimulation, light, heat and/or cold. The wearable sensor device 112 can include a wireless communication transceiver 122 configured to transmit information to and receive information from the smartphone or hub 120. The wearable sensor device 112 can transmit sensor data (e.g., raw sensor data and/or processed sensor data) and metadata about the sensors and/or the sensor data to the smartphone or hub 120 and receive commands and firmware updates from the smartphone or hub 120.

The smartphone or hub 120 can be a computer system capable of wireless communication with the wearable sensor device 112 and can establish a network connection 128 (e.g., the Internet) to the cloud computing platform. The network connection 128 can include one or more wired or wireless (e.g., WiFi, Bluetooth, Cellular Data, 3G, 4G) connections to the cloud computing platform. The smartphone or hub 120 can also include sensors (e.g., GPS, temperature, compass, and other features (e.g., clock, timer, calendar, and weather) that provide access to location, environmental and contextual data and metadata. For example, the smartphone sensors and other features can provide data, such as, location, temperature, and time of day and the metadata can provide rate of change of this data, such as direction and speed/acceleration of movement, change in temperature (e.g., whether the environmental temperature is rising or falling) and whether the environment will be getting lighter or darker.

The smartphone or hub 120 can be a computer system (e.g., one or more processors and associated memory), such as a desktop computer capable of running the Windows (Microsoft, Seattle, Wash.), Macintosh (Apple, Cupertino, Calif.), or Linux operating system, a portable device capable of running Linux, the Windows Phone (Microsoft, Seattle, Wash.), iOS (Apple, Cupertino, Calif.), or Android operating system. In accordance with some embodiments, the smartphone or hub 120 includes an input device such as a keyboard and mouse or a touch screen. In accordance with some embodiments, the smartphone or hub 120 can be remotely accessed, such as by using a remote access protocol (e.g., SSH or PUTTY).

The cloud computing platform 200 can be any system that can receive and store sensor data (e.g., from the smartphone or hub 120), algorithms (e.g., algorithm libraries) and/or programs (e.g., software, or firmware) and provide developers access to that stored data, algorithms and programs. The cloud computing platform can also be used to distribute firmware and algorithm updates. Data in the cloud can be organized by time (e.g. chronologically, by time stamp or time received) or by activity, and may include metadata describing the users (e.g., user characteristics such as age, gender, ethnicity, height, weight, etc.), activity (e.g., walking, running, swimming, resting, gym, shower, sleeping), objectives of the data collection activity, location of sensors, and other information that characterizes the dataset. The cloud platform can store continuous streams of high frequency sensor data and overlays with periodic data based on time stamps and unique recording session identifiers (i.e. protocol ID, subject ID, device ID, etc.)

In accordance with some embodiments, the cloud computing platform 200 can expose or distribute the raw data, labels, and performance targets to algorithm developers (e.g., internal or external) that can collaborate and/or compete (e.g., for points, money, or reputation) to develop and contribute new and improved algorithms that meet or exceed performance goals. Datasets can be accessed through a web service, APIs, and/or downloaded locally. For the purpose of competition, partial datasets may be exposed, without labels. Performance targets can be defined by the user, the data submitter, the challenge administrator and/or refined as algorithms are trained with new datasets. Algorithms can be tested with partial or complete datasets and against ground truth labels to verify performance.

In accordance with some embodiments, if the performance of the new algorithms exceeds that of the old algorithms, or if a new algorithm is developed to measure or track a new activity, the platform can be used to push (e.g., manually or automatically) the new or updated algorithm parameters (e.g., function coefficients) or new or updated algorithms (e.g., updates to the algorithm libraries) into the wearable sensor devices through the smartphone or hub device, such as in the form of a firmware or software update. A new firmware binary can be generated in the cloud. On subsequent connections between the cloud and the smartphone device or sensor hub, the smartphone device can check for new firmware availability, and if present, download the update binary from the cloud. Once the smartphone device stores the new firmware, it can download it onto the wearable sensor through a wireless connection. This process can also occur without downloading or storing firmware binaries on the smartphone device, when connections between the cloud and smartphone or hub, and smartphone or hub to wearable sensor are all present.

FIGS. 1B and 1C show diagrams of wearable sensing devices 112 according to some embodiments of the invention. FIG. 1B shows a wearable sensing device 112 constructed of one or more device islands 210 electrically interconnected by stretchable or flexible interconnects 220 that can enable the wearable sensing device 112 to flex, stretch and/or conform to various locations on the body, including those that have irregular surface geometries according to some embodiments of the invention. The device islands 210 can include two or more flexible circuit boards that enable attachment of the wearable sensing device 112 components, including a microprocessor or micro controller unit (MCU) 211, one or more memory devices 212, one or more power sources, such as a battery 213, accelerometers 216, gyroscopes 216, electrode interfaces 215 (e.g., EEG, EKG and EMG sensors), one or more induction coils 217 for charging the battery 213, a voltage relating and/or charging circuitry 219. The MCU 211 can include a plurality of discrete components, such as a microprocessor and associated interface components or a system on a chip device that can include other optional components including a wireless communications interface. The wearable sensing device 112 can also include one or more wireless communication interface 218 (e.g., Blue Tooth, Blue Tooth Low Energy, Radio Frequency Identification (RFID), Near Field Communications (NFC), WiFi, and/or Zigbee),and associated antenna 218A to enable the wearable sensing device 112 to transmit data to and receive data from the smartphone or hub 120. The wearable sensing device 112 can also send and receive firmware and software to and from a remote device, such as a smartphone or hub 120 or other computerized device, such as a desktop or portable computer. The wearable sensing device 112 can be encapsulated in a silicone, polyimide or other flexible material.

FIG. 1C shows a wearable sensing device 112 constructed of a flexible circuit board and one or more components. The components can include a micro controller unit 232 (e.g., a microprocessor, a system on a chip, an NFC controller or RFID controller), an antenna or coil 218A and a sensor interface 234, such as an analog to digital (A/D) converter or electrode interface (e.g., EEG, EKG, EMG interface). The wearable sensing device 112 can also include one or more wireless communication interface 218 and associated antenna 218A (e.g., Blue Tooth, Blue Tooth Low Energy, RFID, NFC, WiFi, Zigbee), to enable the wearable sensing device 112 to transmit data to and receive data from the smartphone or hub 120. The wearable sensing device 112 can also send and receive firmware and software to and from a remote device, such as a smartphone or hub 120 or other computerized device, such as a desktop or portable computer. The wearable sensing device 112 can be encapsulated in a silicone, polyimide or other flexible material.

In accordance with some embodiments of the invention, the firmware or software can control at least a portion the operation of the wearable sensing device 112. In accordance with some embodiments of the inventions, the wearable sensing device can be controlled, at least in part, by signals (e.g., commands, instructions, parameters, algorithms) received from a remote device, such as the smartphone or hub 120 or a desktop or portable computer. In accordance with some embodiments, the wearable sensing device 112 can be configured to operate in one or more modes of operation, for example, each mode can be configured to use one or more sensors to collect and process sensor signals and produce sensor signal data that can be processed by the wearable sensing device 112 or transmitted to the smartphone or hub 120 for processing or subsequently transmitted to the cloud platform 200 for processing, depending on the mode of operation. The firmware or software can include one or more algorithms (e.g. a library of algorithms and/or a suite of programs) for processing the sensor signal data and produce output information. The algorithms can be selected and modified using parameter data received from the smartphone and/or the cloud computing platform 200. For example, an algorithm can receive accelerometer data while the user is walking or running and process the accelerometer data to produce output information that can include, for example, step count, distance and calories burned.

In addition, the wearable sensing device 112 can include one or more modes of operation that can be used to facilitate development of the firmware, software and/or algorithms. In accordance with some embodiments of the invention, the wearable sensing device 112 can be manually or automatically configured into a mode of operation that stores the raw sensor signals and data (e.g., algorithm parameters, data representative of or derived from the raw sensor signals) and enables this data to be transferred (with or without the output data or other information) to the smartphone or hub 120 and/or to the cloud platform 200 for analysis. The smartphone or hub 112 can also query the user to characterize the activity and send this user ground truth information to the cloud platform 200 along with the raw data. Additional information, such as contextual data and information available from the smartphone carried by the user (e.g., GPS data, environmental data such as temperature and humidity, accelerometer and gyroscope data) can also be sent to the cloud platform 200. In accordance with some embodiments, the smartphone or hub 120 can include software (e.g., an application or app) that collects some or all of the sensor data available from the smartphone 120 and sends it to the cloud platform 200 along with the raw sensor data. This data enables the algorithm developers to better evaluate how the raw data is processed by their algorithms and modify the firmware, software and/or algorithms to produce more accurate output information.

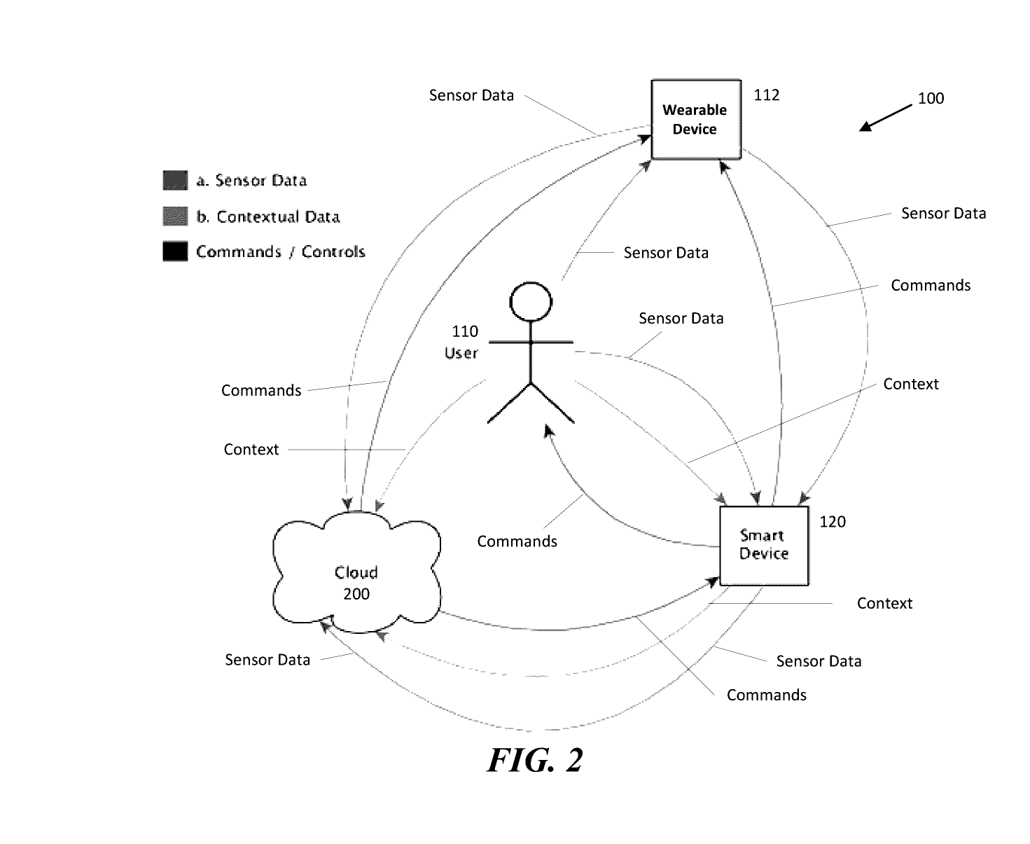

FIG. 2 shows a diagrammatic view of the information flow in the system 100 according to some embodiments of the invention. Sensor data (e.g., physiological measurements) includes data that originates from the user and are captured by the wearable sensor device 112 and/or the smartphone or hub 120, using on-board sensors (e.g., accelerometers, gyroscopes, electrodes, magnetometers, temperature sensors, heat flux sensors, perspiration sensors, fluidic sensors.) In addition to embedded motion sensors, the wearable sensor device 112 and/or the smartphone or hub 120 can include location sensors (e.g., GPS), light, sound, proximity, touch, and other environmental sensors. Sensor data output from the wearable sensor device 112 and/or the smartphone or hub 120 can be in raw or processed form, depending on the required level of granularity for the algorithms. The wearable sensor device 112 obtains sensory input (e.g., movement, heart rate, temperature, heat flux, electromyography, electrocardiography, galvanic skin response, perspiration) and the smartphone or hub 120 obtains sensory input (e.g., movement, temperature, light, sound, proximity, and touch) from the subject or user 110. Contextual data originates from the user and can be captured through a user interface, such as within an application either on a smartphone or hub 120 or web (e.g., accessed through the smartphone or hub 120). Contextual data can include subjective and demographic (e.g. biometric data: age, gender, height, weight) and (e.g. subjective data: mood, symptoms, medication, medical status) input, activities, events, and confirmation of activities of daily life (ADL). This data can be time stamped and used alongside the more objective sensor data. Contextual data can also include metadata. The smartphone or hub 120 obtains contextual data from the user 110, for example, using an application executed on the smartphone or hub 120 or via a web based user interface using the smartphone or hub 120. In accordance with some embodiments, the application or the web-based user interface can provide a prepopulated list of activities or events and ask the user to select from the list. In accordance with some embodiments, the application or the web-based user interface can provide an open text field and ask the user to type in a custom user response (e.g. walk, run, swim, rest, sleep, work, gym, shower, etc.). The user selected and/or entered data can be stored locally on the smartphone or hub 120 and uploaded to the cloud computing platform 200. The cloud computing platform 200 obtains contextual data from the user 110. The smartphone or hub uploads contextual data through an API. Data can be time stamped (e.g., metadata attached to transmitted data streams and packets) and transmitted with corresponding metadata to enable grouping recording session and additional data streams.

As shown in FIG. 2, the wearable sensor device 112 communicates sensor data and/or algorithm output to the smartphone or hub 120 (e.g., using a wireless communication facility, such as Bluetooth, Near Field Communication, RFID WiFi,) and the smartphone or hub 120 communicates the sensor data to the cloud computing platform 200 (e.g., using WAN technologies, such as, WiFi, cellular data, 3G, 4G). In accordance with some embodiments, the wearable sensor device 112 can communicate sensor data directly to the cloud, for example, using a wireless communication facility (e.g., WiFi, cellular data, 3G, 4G). In accordance with some embodiments, the cloud computing platform 200 can send commands and control information to the smartphone or hub 120 and the smartphone or hub 120 can send commands and control information to the wearable sensor device 112 and to the user 110. Firmware uploads can be achieved by the cloud sending the binary from the cloud to the smartphone or hub. Similarly, algorithm updates can be achieved by the cloud sending updated algorithm parameters to the smartphone or hub 120. The user can then be prompted within the smartphone application that a new software versions or algorithm update is available, which the user can install onto wearable sensor device. An event schedule command can also be generated by the cloud and sent to the smartphone or hub, which notifies the user about a scheduled event (i.e. walk test), for example by putting it on the user's calendar or through an application generated pop-up message. The user can execute this event through the smartphone application, which can consequently set the wearable sensor device into a specific recording mode based on scope of activity. (i.e. activate accelerometer sensor and execute an appropriate sensor software application).

In accordance with some embodiments, once the time-based sensor and contextual data are stored and analyzed in the cloud, the algorithms in the cloud can issue additional commands that are sent to the smart device, or directly to the wearable computer (i.e. via WiFi). The commands sent to the smart device may consist of prompting the user to tag an activity, confirm an activity, or perform a specific activity. This data, requested by the system, can be used by the developers to develop and improve the algorithms and/or algorithm parameters. The user can be prompted to enter this data if the algorithm detects a low confidence in accuracy. Dynamically retrieving user input to compliment objective sensor data can be used to retrain algorithms and to provide more individualized or customized algorithms.

In accordance with some embodiments, the cloud computing platform 200 can also send commands directly to the wearable computer, or through the smartphone or hub 120, to change firmware modes. In accordance with some embodiments of the invention, the firmware architecture provides that the firmware can be programmed or configured to store various levels of data granularity (raw, algorithm output, algorithm output+features) to facilitate algorithm and firmware development. A low confidence output can be used to trigger a temporary higher granularity data output mode, where the firmware switches from a processed output (with efficient data throughput) to a raw output for diagnosis and analysis (with less efficient data throughput). Once analyzed in the cloud, a new or improved algorithm can be developed and pushed out to the wearable sensor devices in the form of a firmware update (directly or via smartphone or hub 120) to optimize data flow efficiency.

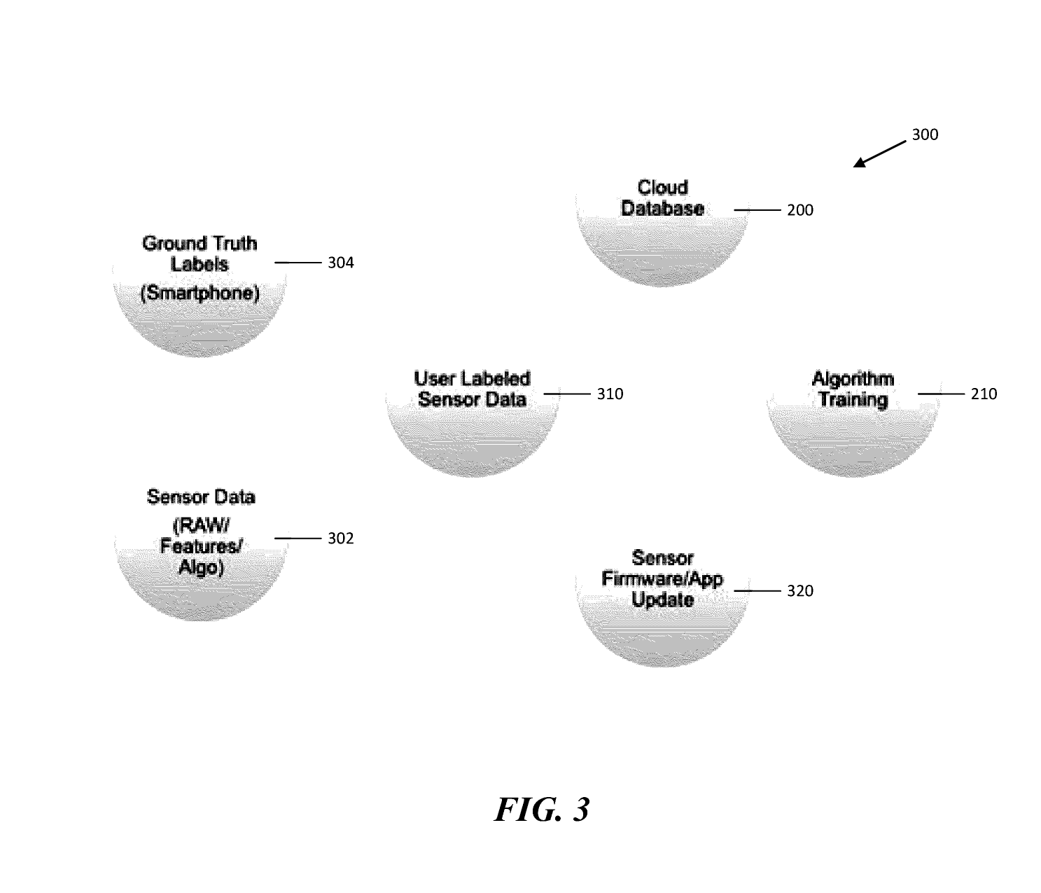

FIG. 3 shows a diagrammatic view of the work flow of the system in accordance with some embodiments of the invention. The sensors in the wearable sensor device 112 generate raw data and features by sensing the user 110. The firmware or software in the wearable sensor device 112 can process the data and features from the sensors and generate more sensor data. The raw data and features 302, as well as any software generated sensor data can be communicated to the smartphone or hub 120. The smartphone or hub 120 can include additional algorithms that process some or all of the data received from the wearable sensor device 112 and generate more sensor data. In addition, the smartphone or hub 120 can prompt or query the user 110 for information about their current state or the nature of an activity previously or currently conducted. The user's input can include ground truth labels 304 about the activity and provide additional data and/or metadata about the data received from the wearable sensor device 112 and the smartphone or hub 120. This enables the smartphone or hub 120 to send user labeled sensor data 310 to the cloud computing platform 200.

In accordance with some embodiments, developers can access the user labeled sensor data 310 from the cloud computing platform 200 and use this data to develop and/or train software algorithms 320 to characterize the user's activity based on the sensor data 302. The software algorithms 320 can be sent (e.g., downloaded) to the wearable sensor device 112 as an update to improve the operation of the wearable sensor device 112. This can be part of an ongoing process of improvement, wherein new data 302 and ground truth labels 304 are continuously combined (e.g., into user labeled sensor data) and uploaded to cloud computing platform 200 to enable developers to train their software algorithms 210 and update their firmware or software 320.

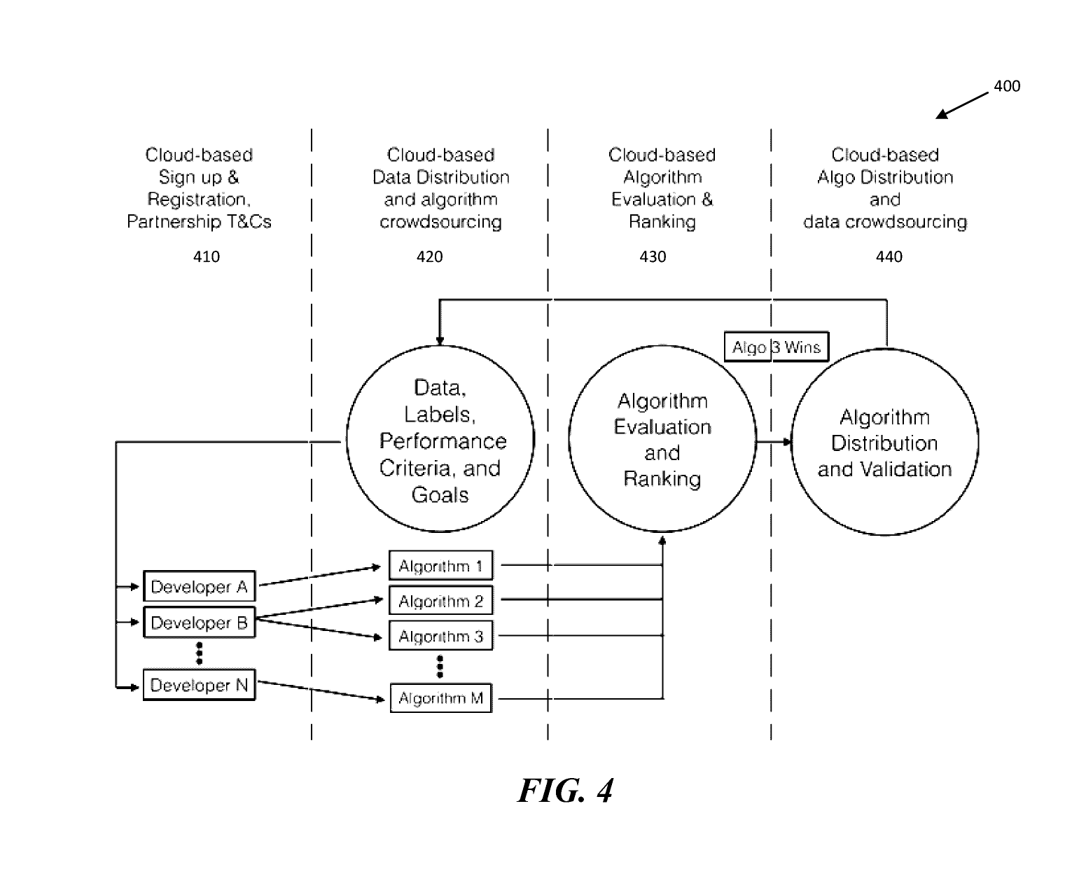

FIG. 4 shows a diagrammatic view of the cloud computing platform 400 according to some embodiments of the invention. The cloud computing platform 400 can include a registration module 410 that enables developers or developer teams to sign-up and register to gain access to data, labels, performance criteria and goals (e.g. confidence interval greater than 90%, outcome probability greater than 85%, standard deviation of outputs, etc.). The cloud computing platform 400 can also include storage for data, labels, performance criteria and goals (e.g. a database). The cloud computing platform 400 can also include an algorithm evaluation module 430 that evaluates software algorithms uploaded by developers. Test algorithms can run through higher order, validated algorithms and complete datasets for evaluation. The cloud computing platform 400 can also include a data collection module 440 that communicates with the smartphone or hub 120 to collect user data. The data collection module can also be used to distribute firmware or software updates based on the evaluation and ranking of the software algorithms submitted by developers.

In accordance with some embodiments, the wearable sensing device 112 or the wearable sensing device 112 in combination with the smartphone or hub 120 can be configured to facilitate algorithm development by providing more or less data based the context of the activity of the user 110 and the state of algorithm development. For example, for new algorithm development, the wearable sensing device 112 (and optionally, in combination with the smartphone or hub 120) can be configured to provide raw data to cloud computing platform 200 to enable the developers to analyze the raw data and develop algorithms to characterize the activity based on the raw data. For example, the smartphone or hub 120 can prompt the user to perform an action or begin an activity (e.g. to 20 jumping jacks or run 1000 ft.) and the wearable sensing device 112 (and optionally, in combination with the smartphone or hub 120) can be configured to send the raw data with one or more ground truth labels to the cloud computing platform to enable the labeled data set to analyzed by developers to facilitate new algorithm development. In accordance with some embodiments, the wearable sensor device 112 can be configured to store the raw sensor data in one or more files in a file system in the memory of the wearable sensor device 112. In accordance with some embodiments, the smartphone or hub 120 can be configured to store the raw sensor data in one or more files in a file system in the memory of the smartphone or hub 120.

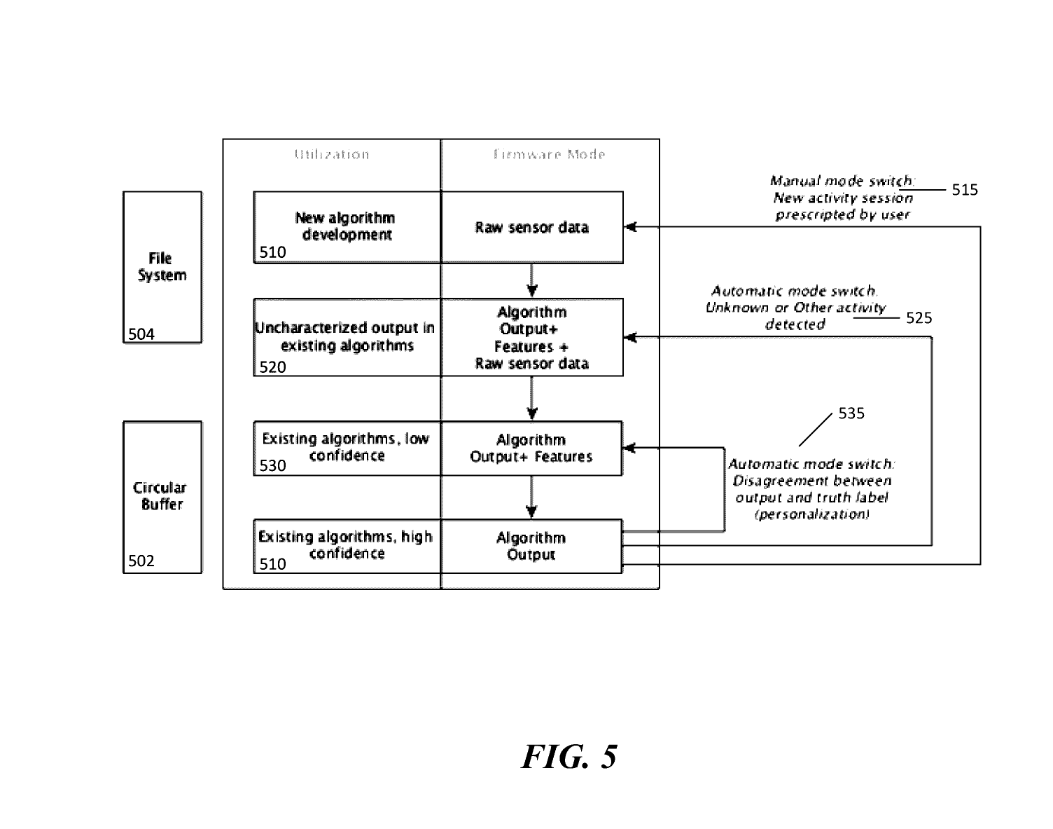

In accordance with some embodiments, the wearable sensor device 112 can be configured to facilitate development (e.g., improvement) of existing algorithms, such as to better detect known activities or to detect new activities. For example as shown in FIG. 5, when an existing algorithm is unable to detect an activity (e.g., it is unable to characterize the data), the wearable sensing device 112 (and optionally, in combination with the smartphone or hub 120) can be configured to provide additional data (e.g., an algorithm identifier, the algorithm output, data or signal features and raw sensor data) to the cloud computing platform 200 to enable the developers analyze the data and modify the software and/or the algorithm. In accordance with some embodiments, when the firmware/software is unable to characterize the user activity, the wearable device 112 can automatically switch to a mode wherein additional data, such as algorithm identifier, data or signal features and raw sensor data in addition to the algorithm output are sent to the smart hub 120 and/or cloud computing platform 200. In accordance with some embodiments, the wearable sensor device 112 can be configured to store the algorithm identifier, the algorithm output, data or signal features and raw sensor data in one or more files in a file system in 504 the memory of the wearable sensor device 112. In accordance with some embodiments, the smartphone or hub 120 can be configured to store algorithm identifier, the algorithm output, data or signal features and the raw sensor data in one or more files in a file system 504 in the memory of the smartphone or hub 120.

In accordance with some embodiments, the wearable sensor device 112 can be configured to facilitate development (e.g., improvement) of existing algorithms, such as to better detect known activities. For example, when an existing algorithm has a low confidence level for detecting an experienced activity, the wearable sensing device 112 (and optionally, in combination with the smartphone or hub 120) can be configured 530 to provide additional data (e.g., the algorithm output, and data or signal) to cloud computing platform 200 to enable the developers analyze the data and modify the software and/or the algorithm to improve the confidence of detection. In accordance with some embodiments, the wearable sensor device 112 can be configured to store the algorithm output and one or more data or signal features in one or more circular buffers 502 in the memory of the wearable sensor device 112. In accordance with some embodiments, the smartphone or hub 120 can be configured to store the algorithm output and one or more data or signal features in one or more circular buffer 502 in the memory of the smartphone or hub 120. In accordance with some embodiments of the invention, the wearable sensing device 112 (and optionally, in combination with the smartphone or hub 120) can be configured 535 to switch to this mode when the algorithm output does not agree with one or more ground truth labels.

In accordance with some embodiments of the invention, as shown in FIG. 5, the wearable sensing device 112 can include an existing algorithm for processing the raw sensor data and producing output data that can be transferred through the smart phone or hub 120 to the cloud computing platform 200 under a normal operating mode 510. The wearable sensing device 112 can include one or modes that can be used to facilitate algorithm development (including debugging and improvement). In a first development mode 510, the wearable sensing device 112 is configured to execute an algorithm (e.g., such as, an algorithm under development or where a new activity is identified by the user 515) and transfer raw sensor data through the smart phone or hub 120 to the cloud computing platform 200. This first development mode 510 enables the developers to access and analyze the raw sensor data to develop (and/or modify) the algorithms so that they can appropriately interpret the data according to the detected or user indicated activity. In a second development mode 520, the wearable sensing device 112 is configured to execute an existing algorithm (e.g., such as, an algorithm under development or where an unknown activity is detected 525 and the algorithm is unable to characterize or process the raw sensor data) and transfer algorithm output, feature data and raw sensor data through the smart phone or hub 120 to the cloud computing platform 200. This mode enables the developers to improve existing algorithms by enabling them to characterize previously unknown or other activity or data. In the third development mode 530, the wearable sensing device 112 is configured to execute an existing algorithm (e.g., such as, an algorithm under development or where an unknown activity is detected 525) and transfer algorithm output, and feature data through the smart phone or hub 120 to the cloud computing platform 200. This mode enables the developers to improve existing algorithms by enabling them to appropriately characterize known activity.

In accordance with some embodiments, the wearable sensing device 112 can automatically switch between modes as a function of one or more signals or information from the algorithm. For example, where the signals or information indicate a disagreement between the activity determined by the algorithm and the activity indicated or selected by the user 535, the wearable sensing device 112 can automatically switch to the third developer mode 530 to collect additional data (e.g., feature data) to improve the algorithm. In another example, where the signals or information indicate that the detected activity is unknown or new to the algorithm 525, the wearable sensing device 112 can automatically switch to the second developer mode 520 to collect additional data (e.g., feature data and raw data) to improve the algorithm. In another example, where the signals or information indicate that the detected activity is a new activity identified by the user 515, the wearable sensing device 112 can automatically switch to the first developer mode 510 to collect additional data (e.g. raw data) to facilitate development of an algorithm (or a modification of an existing algorithm) to properly characterize the new activity.

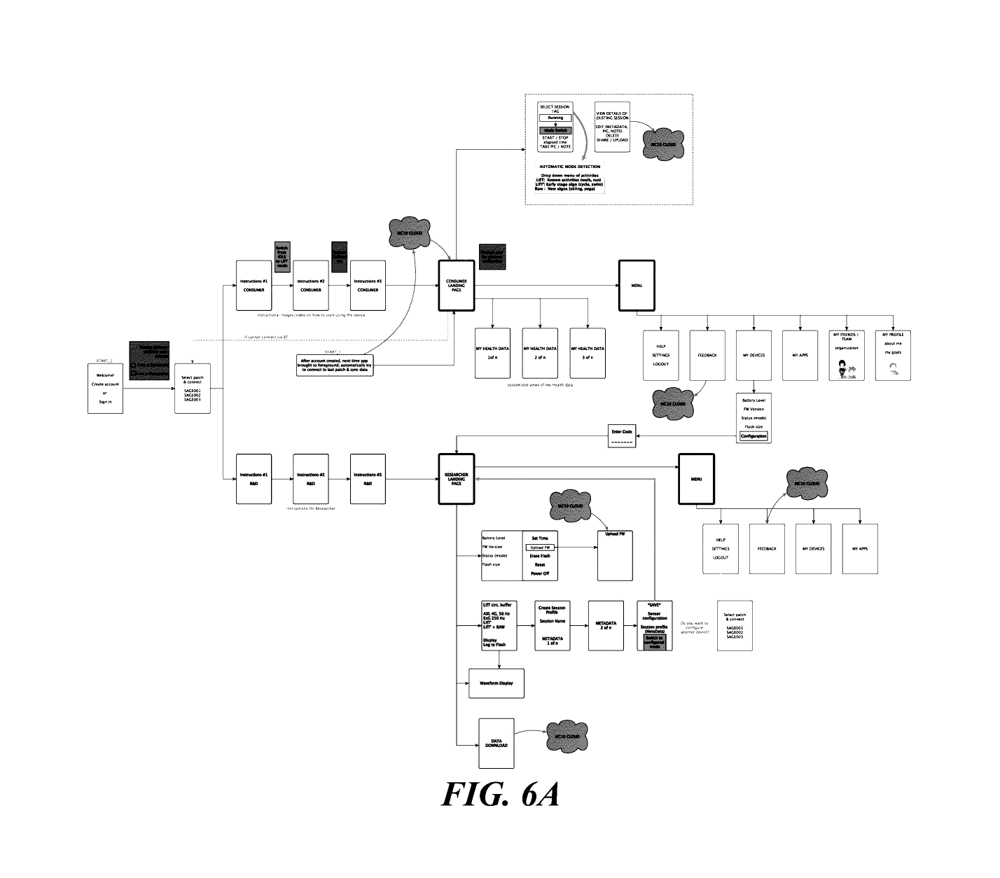

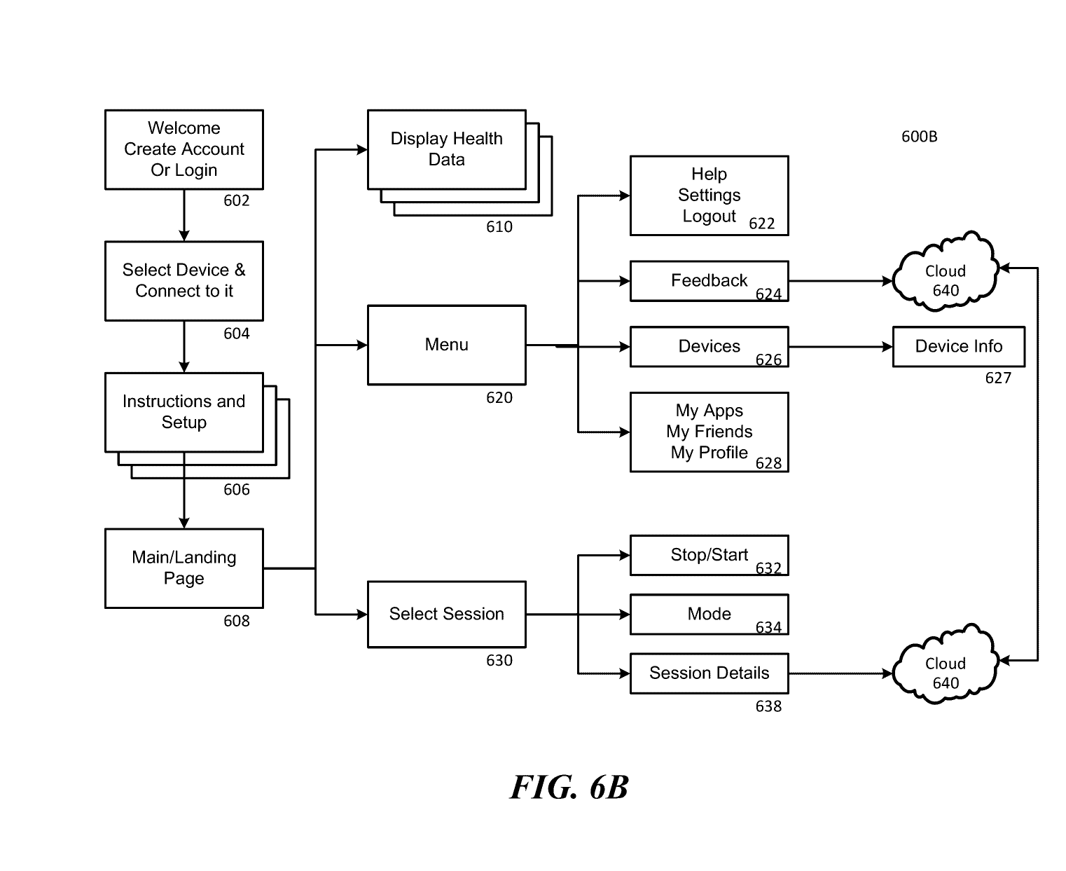

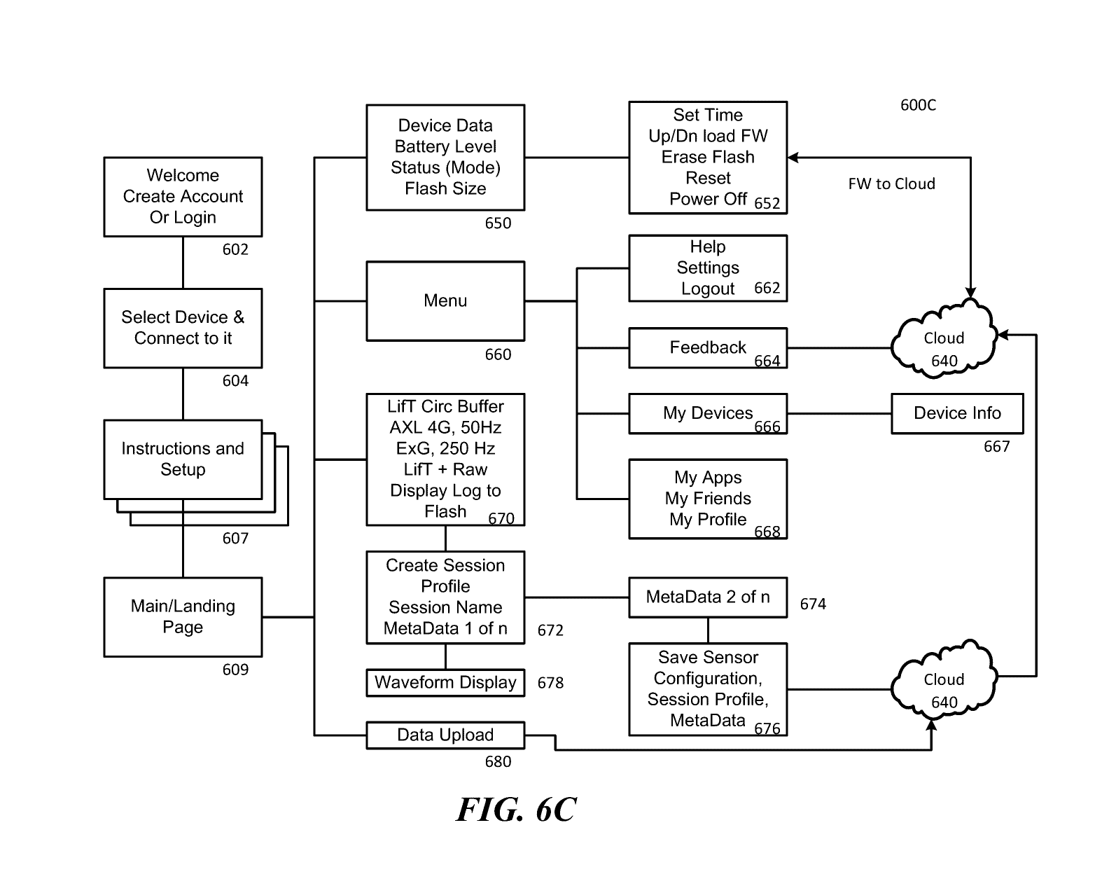

FIG. 6A shows a diagrammatic view of the smartphone or hub application according to some embodiments of the invention. The application provides a control and command interface to and from the wearable sensor, and also provides a data and information conduit or gateway enable data to be transferred to and from the cloud computing system. The activity labels selected by the user can switch the firmware into modes, depending upon the algorithm maturity for each one of the activities. For instance, if the user selects walking (a high confidence interval activity) known to the system, the firmware switches to algorithm output mode (e.g., the walking algorithm), whereby output data stream is transferred from the sensor to the smartphone and onward to the cloud. Consequently, if the user selects biking (a low confidence interval) the firmware switches to raw data collection mode, since no algorithm is available.

FIGS. 6B and 6C show portions of the application workflow shown in FIG. 6A. In accordance with some embodiments of the invention, the application can support two or more modes of operation, for example as shown in FIG. 6A, the application can include a consumer or user mode and researcher mode. The consumer or user mode can provide access to user functionality, to enable the user to use the device with minimum training or supervision. The researcher mode can provide the researcher with access to additional functionality that enables the researcher to evaluate the operation of the wearable device and data generated by the device, to evaluate the performance of algorithms executed by the device (e.g., by communicating with the wearable device) and algorithms executed by the smart phone or hub. The researcher can also administer and monitor activities that are performed by the wearer of the wearable sensing device. In the researcher mode, the researcher can interact with and control the operation of the wearable sensing device, for example, using a smartphone or hub 120 or other similar device.

FIG. 6B shows an example of a user mode application process or workflow 600B according to some embodiments of the invention. The initial or startup screen 602 displays a welcome screen that invites a user to create an account or login if an account was already created. Next, at 604, the application enables the user to select and connect to the wearable device. This enables the application to interact with more than one wearable device worn by the user. At 606, the application can present the user with one or more screens or pages that provide the user with instructions for setting up and/or using the device. At 608, the application presents the main/landing page or screen that can include one or more menus that provides access to user functionality. For example, one menu option can include displaying health data 610 that can be received from the wearable device, such as body or skin temperature, heart rate, respiration rate, EMG and/or EKG signals on one or more pages. Another menu option can include specific user functions 620, including Help (e.g., information about how to use the application and the wearable device) 622, Settings (e.g., user changeable settings) 622, Logout (e.g., user logout of their account in the application) 622, Feedback (e.g., provide feedback to the issuer or provider of the wearable device) 624, Wearable device information (e.g., information about the status of the wearable device 627, such as battery level, firmware version, status of the device, current mode of operation of the device, memory size, and configuration of the device) 626. The configuration menu can require a password, access code or series of user inputs to access to enable the user to reconfigure the wearable or simply change its mode of operation (e.g., from running to swimming). Another menu option 628 can enable the user access other applications (“apps”) running on the device including applications that interact with the wearable device, applications that interact with other people and applications that store information about the user and their goals and/or past performance. This menu option can also enable the user to create, view or edit their user profile.

Another menu option can facilitate activity selection 630. In accordance with some embodiments of the invention, the wearable device can determine the activity of the user based on user motion and physiological signals (e.g., as a function of sensor data reflecting user motion and physiological changes) and send commands to configure the smart phone or hub to execute a predefined application or algorithm associated with the detected activity. In accordance with some embodiments of the invention, the user can select the activity from the session selection menu 630 and start/stop 632 or otherwise control the recording of data associated with the activity. The user can also set and/or change the mode of operation 634 (e.g., from accelerometer based heart rate detection mode to EKG based heart rate detection mode or step count mode to respiration monitoring mode). The user can also view 638 detailed information about the activity session (e.g., length of time, distance traveled). The session information can be sent to cloud 640 for further analysis and for algorithm development.

FIG. 6C shows an example of a researcher or developer mode application process or workflow 600C according to some embodiments of the invention. The initial or startup screen 602 displays a welcome screen that invites a researcher to create an account or login if an account was already created. Next, at 604, the application enables the researcher to select and connect to the wearable device. This enables the application to interact with more than one wearable device worn by a user. At 607, the application can present the researcher with one or more screens that provide the researcher with instructions for setting up and/or using the wearable device. At 609, the application presents the main/landing page or screen that can include a menu that provides access to researcher functionality screens. For example, one menu option can include displaying device status and information 650 such as device data, battery charge level, status or mode of operation, and memory information (e.g., size and usage). The device status and information page 650 can also include one or more submenus 652 that enable the researcher to set the device time and date, upload and/or download firmware to and from the cloud storage facility 640, erase one or more of the memories in the device, reset the wearable device, and power off the device on one or more pages. Another menu option can include specific researcher functions 660, including Help (e.g., information about how to use the application and the wearable device) 662, Settings (e.g., researcher changeable settings) 662, Logout (e.g., researcher logout of their account in the application) 662, Feedback (e.g., provide feedback to the issuer or provider of the wearable device) 664, Wearable device information (e.g., information about the status of the wearable device 666, such as battery level, firmware version, Status of the device, current mode of operation of the device, memory size, and configuration of the device) 667. Some of the menus can require a password, access code or series of user inputs to access to enable the researcher to reconfigure the wearable or simply change its mode of operation (e.g., from running to swimming). Another menu option 670 can display the sensor configuration to the researcher, providing detailed information about the sensors and their mode of operation (e.g., which sensors are enabled to sense activity and the sampling rate, as well as whether the device is storing raw sensor data or processed sensor data) including the ability to change the mode of operation, and define and save session configuration profiles 672, 674, 676 (e.g., enable or disable individual sensors, set their sampling rate, and/or specify whether raw sensor data, processed sensor data or both are stored in memory). In one submenu, the smart phone or hub can provide a waveform display 678 of the sensor data received from the wearable device. In one submenu, the smart phone or hub can upload the sensor data 680 to the cloud 640 for further analysis and for algorithm development.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system comprising
a wearable sensing device including one or more sensors and a wireless communication facility enabling the wearable sensing device to communicate with a remote computer system;
a hub including a wireless communication facility enabling the hub to communicate with the wearable sensor device and a network communication facility enabling the hub to communicate with a cloud computing platform over a network; and
a cloud computing platform connected to a network and configured to receive data from the smart device over the network.

2. The system according to claim 1 wherein the one or more sensors produce sensor data and the wearable sensor device includes firmware and the firmware includes at least one algorithm for processing the sensor data and generating an algorithm output.

3. The system according to claim 2 wherein the wearable sensing device transmits the algorithm output to the hub and the hub transmits the algorithm output to the cloud computing platform.

4. The system according to claim 2 wherein the wearable sensing device transmits the sensor data to the hub and the hub transmits the sensor data to the cloud computing platform.

5. The system according to claim 2 wherein the wearable sensing device transmits the sensor data and the algorithm output to the hub and the hub transmits the sensor data and the algorithm output to the cloud computing platform.

6. The system according to claim 2 wherein the wearable sensing device transmits at least one of raw sensor data, algorithm parameters, data features, and an algorithm identifier associated with the at least one algorithm, to the hub and the hub transmits at least one of raw sensor data, algorithm parameters, data features, and an algorithm identifier associated with the at least one algorithm to the cloud computing platform.

7. The system according to claim 6 wherein the cloud computing platform includes data storage storing at least one of the raw sensor data, the algorithm parameters, the data features, and the algorithm identifier.

8. The system according to claim 2 wherein the cloud computing platform includes data storage storing at least one of the sensor data, the algorithm output, and the firmware.

9. The system according to claim 1 wherein the hub receives firmware from the cloud platform using the network communication facility and the hub transmits the firmware to the wearable sensing device using the wireless communication facility.

10. A wearable sensing device comprising:
a processor and associated memory, the memory storing firmware including instructions executable by the processor to control the operation of the wearable sensing device;
one or more sensors configured to produce sensor data;
a communication facility adapted for communicating with a remote hub;
wherein the firmware includes at least one algorithm that processes the sensor data to produce algorithm output, and the firmware defines at least two operating modes whereby;
in a first operating mode, the wireless sensing device uses the communication facility to transmit algorithm output to the remote hub; and
in a second operating mode, the wireless sensing device uses the communication facility to transmit sensor data to the remote hub.

11. The wearable sensing device according to claim 10 wherein wearable sensing device switches from the first operating mode to the second operating mode in response to a signal from the remote hub.

12. The wearable sensing device according to claim 10 wherein wearable sensing device switches from the second operating mode to the first operating mode in response to a signal from the remote hub.

13. The wearable sensing device according to claim 10 wherein the algorithm determines a level of confidence for the algorithm output in the first mode of operation and automatically switches to third mode of operation that uses the communication facility to transmit algorithm output and features to the remote hub when the level of confidence is below a predefined threshold.

14. The wearable sensing device according to claim 10 wherein the algorithm unable to characterize the sensor data and automatically switches to third mode of operation that uses the communication facility to transmit sensor data, algorithm output and features to the remote hub when the level of confidence is below a predefined threshold.
